(19) United States
(12) Patent Application Publication
(10) Pub. No.: US 2017/0140067 A1
(43) Pub. Date: May 18, 2017

(54) Method Having a Search Program and a Search Box

(71) Applicant: SICK AG, Waldkirch (DE)

(72) Inventors: Martin BEHA, Waldkirch (DE); Mathis ZEIHER, Waldkirch (DE)

(21) Appl. No.: 15/237,076

(22) Filed: Aug. 15, 2016

(30) Foreign Application Priority Data
Nov. 12, 2015 (EP) 15194352.9

(51) Int. Cl. G06F 17/30; G06F 3/0482

(52) U.S. Cl. CPC G06F 17/30973; G06F 17/30864; G06F 3/0482

(57) ABSTRACT

A method having a search program (15) and a search box (5) for searching and locating parameters (2) and/or process data (3) in a web application (4) which is provided for operating and visualizing at least one field instrument (1), wherein the web application (4) for the search dynamically produces the parameters (2) and/or process data (3) from an operating interface (6) at the running time, with the operating interface (6) having at least one searchable data structure (7).

The present invention relates to a method having a search program and a search box for a field instrument in accordance with the preamble of claim 1.

The invention in particular relates to field instruments of process automation, that is, for example, transmitters, in particular O₂ transmitters, field instruments for flue gas analysis such as particle measuring instruments, laser scanners or the like. Such field instruments frequently have a web application via which the field instrument can be configured or parameterized.

A complexity of such field instruments is constantly increasing. This inter alia has a great effect on the number of available parameters and process data. The location of parameters and/or process data, their values and their properties have proven to be difficult or impossible for an untrained user. The parameters and/or process data are typically distributed over different pages and in different menu levels of an operating interface.

DE 10 2008 043 198 A1 discloses a field instrument having an index file for searching for parameters of the field instrument.

DE 10 2011 101 146 A1 discloses a method and a device for a multi-stage location of instrument data of a field instrument of an automation system on the basis of a database file.

DE 10 2011 053 951 A1 discloses a method to access process data of a field instrument, wherein a database is searched through for a descriptor file.

DE 10 2011 053 844 A1 discloses a search service at a process control system.

A use of pre-generated index files and databases has specifically proved to be inflexible in practice.

An object of the invention is to simplify the location of parameters and/or process data.

The object is satisfied in accordance with claim 1 by a method having a search program and a search box for searching and locating parameters and/or process data in a web application which is provided for operating and for visualizing at least one field instrument, wherein the web application for the search dynamically produces the parameters and/or process data from an operating interface at the running time, with the operating interface having at least one searchable data structure.

The invention allows the location of parameters and/or process data as well their contents and properties in pages dynamically generated or dynamically produced by a web application or in a dynamically produced menu structure of the operating interface. The parameters and/or process data are produced dynamically from the operating interface by the web application likewise at the running time.

A dynamic production means that the production takes place during the execution, that is during the running time of the web application. Additional data therefore do not need to be produced before the execution of the web application.

The currently dynamically produced operating interface is searched on the basis of the input search criterion.

The simple location of parameters or process data as well as their values and properties in dynamically generated or produced pages or menu structures is simplified in accordance with the present invention since in accordance with the present invention no index file or search database has to be produced.

The search is carried out at a search time with reference to the current operating interface. Data and their properties produced dynamically by the field instrument can thus likewise be found.

The search is possible in a standard browser without any installation of plug-ins. The search can thereby be carried out in any standard browser, whereby the user is free in the selection of the browser. The search is additionally a part of the web application and not of the browser so that a standard browser can be used.

The presence of a web server which carries out a search is also not necessary. The search is only carried out at the client side, that is at the application side, namely on the computer or personal computer on which the browser with the web application is executed, for example.

Furthermore, no storage space for a database or an index file is required either in the client or in the computer or personal computer on which the web application or the standard browser is executed or in the field instrument. The search is thus optionally independent of the field instrument. The field instrument itself, that is, for example, the processor, the memory or the communication means of the field instrument, is not additionally strained by the search.

In a further development of the invention, the data structure has contents of an application description file. An application description file, for example a file in the XML format, includes metadata on the actual operating interface or on the application program. The graphical operating interface per se is, for example, defined and its contents are defined by the application description file.

The operating interface is in this respect present in the form of a searchable data structure. The data structure can in this respect likewise be present in the XML format.

The web application produces the parameters and/or process data or parameters and/or process data pages dynamically at the run time from the application description file.

In a further development, the data structure has dynamic values with properties of the field instrument.

The search is thus also able to find combinations of properties and current and variable, that is dynamic, process data. For example, all the parameters outside a specification or all the parameters below a specific value can be searched for and found.

In accordance with a preferred embodiment of the invention, suggestions are displayed by means of an autocomplete on an input of parameters or process data into the search box.

Depending on the autocomplete, the search criterion does not have to be completely input by the user. For example, only a specific number of the letter sequences, character sequences and/or numerical sequences has to be input. All the parameters and/or process data are thereupon displayed which have the sequences of letters, characters or numbers. For example, the autocomplete can only take place for valid initial characters such as letters, characters or numbers. Accordingly, a check is only made whether the searched parameter and/or the process data agree(s) with an initial sequence and only the possible parameters and/or process data are displayed which agree with this initial sequence.

In accordance with a particularly preferred embodiment of the invention, the parameters and/or process data displayed in the search box are clicked directly and a direct jump thereupon takes place to the corresponding parameter page and/or process data page. A particularly efficient and fast selection of the desired parameter or of the desired process data can thereby take place. Only the search box thereby has to be provided and no additional further selection box. The search box optionally only has a plurality of lines which, similar to a pull-down menu, automatically pop up when a plurality of parameters are possible in view of the search query.

In a further development of the invention, a summary page is produced on which all the parameters and/or process data are displayed which meet the search criterion. A summary page is only produced if a plurality of parameters and/or process data are possible in view of the search result. This is advantageous, for example, when a large number of parameters and/or process data have very similar designations such as standard designations such as “Temperature_container_01”, “Temperature_container_02”, etc.

In a further development of the invention, the search criterion is controlled on the basis of a semantic search with the aid of a domain-specific language.

A semantic search is a search method in which the meaning of the search query forms the focus. The content meaning of texts and search queries is taken into account by the use of background knowledge with a semantic search engine. A search is not only made for words, letters, characters and/or numbers. A search query can thereby be detected more precisely and brought into association with the texts of relevant content. Search results of correct context are thus provided.

A domain-specific language is in this respect a very special or specialized application-specific programming language in contrast to a universally usable programming language such as C or Java.

Predefined search criteria can furthermore also be used. In this respect, specific parameters and/or process data are suggested to the user for the search without him having made an input into the search box. This has the advantage that the user already receives an indication as to which syntax or which name definitions the parameters and/or process data have by the predefined search criteria.

In a further development, the search for parameters and/or process data is carried out on the field instrument, with the search criterion being transmitted to the field instrument and evaluated in the field instrument. Only one input device or one input/display device is thereby required to be able to input the search query and to be able to display the search result. The search itself, however, runs on the field instrument anyway present.

In accordance with a further development, the search program is prepared in a programming language for graphical user interfaces. The programming language can, for example be Java or C# and optionally associated development tools.

The invention will also be explained in the following with respect to further advantages and features with reference to the enclosed drawing and to embodiments. The FIGURE of the drawing shows in:

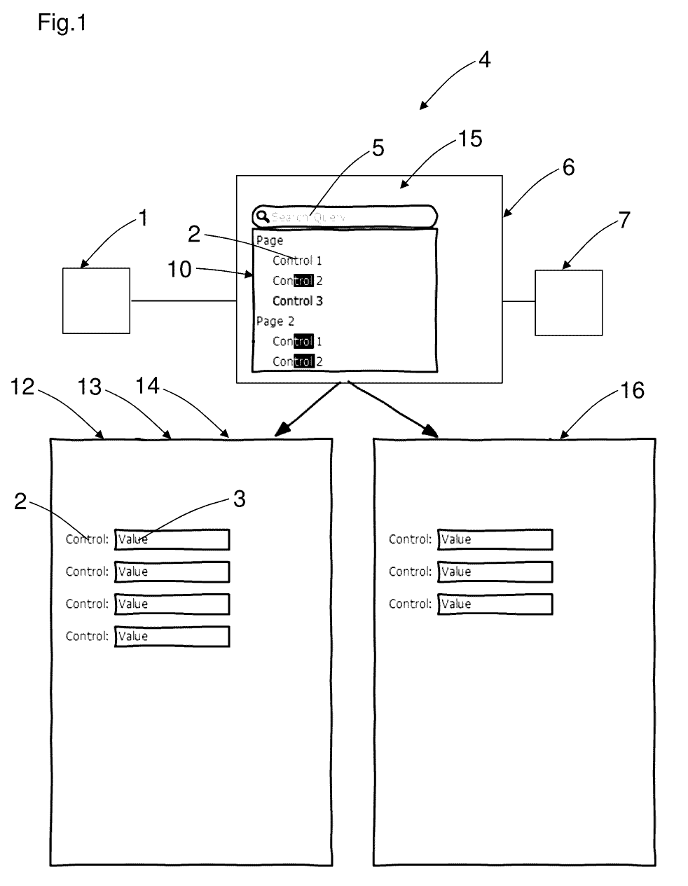

FIG. 1: a method having a search program and a search box for searching and locating parameters and/or process data for a field instrument.

In the following FIGURE, identical parts are provided with identical reference numerals.

FIG. 1 shows a method having a search program 15 and a search box 5 for searching and locating parameters 2 and/or process data 3 in a web application 4 which is provided for operating and visualizing at least one field instrument 1, wherein the web application 4 dynamically produces the parameters 2 and/or process data 3 from an operating interface 6 at the running time, with the operating interface 6 having at least one searchable data structure 7.

The currently dynamically produced operating interface 6 is searched on the basis of the input search criterion.

The search is carried out at a search time with reference to the current operating interface 6. Data and their properties produced dynamically by the field instrument 1 can thus likewise be found.

The search can be carried out with practically any standard browser. The search is part of the web application 4 and not of the browser.

The search is only carried out at the client side, that is at the application side, namely on the computer or personal computer on which the browser with the web application 4 is executed, for example.

The data structure has contents of an application description file. An application description file, for example a file in the XML format, includes metadata on the actual operating interface 6 or on the application program. The graphical operating interface 6 per se is, for example, defined and its contents are defined by the application description file.

The operating interface 6 is in this respect present in the form of a searchable data structure 7. The data structure 7 can in this respect likewise be present in the XML format.

The web application produces the parameters 2 and/or process data 3 or parameters and/or process data pages dynamically at the run time from the application description file.

In accordance with FIG. 1, the data structure 7 has dynamic values with properties of the field instrument 1.

The search is thus also able to find combinations of properties and current and variable, that is dynamic, process data 3. For example, all the parameters outside a specification or all the parameters below a specific value can be searched for and found.

In accordance with FIG. 1, on an input of parameters 2 and/or process data 3, suggestions are displayed in the search box by means of an autocomplete.

Depending on the autocomplete 10, the search criterion does not have to be completely input by the user. For example, only a specific number of the letter sequences, character sequences and/or numerical sequences has to be input. All the parameters 2 and/or process data 3 are thereupon displayed which have the sequences of letters, characters or numbers. For example, the autocomplete can only take place for valid initial characters such as letters, characters or numbers. Accordingly, a check is only made whether the searched parameter 2 and/or the process data 3 agree(s) with an initial sequence and only the possible parameters 2 and/or process data 3 are displayed which agree with this initial sequence. In accordance with FIG. 1, the character sequence ‘trol’ could be input, for example. In this respect, the parameters ‘Control 1’, ‘Control 2’, etc. are displayed and the searched character sequence ‘trol’ is highlighted in the search result.

In accordance with FIG. 1, the parameters and/or process data displayed in the search box are clicked directly and a direct jump to the corresponding parameter page 12 and/or process data page 13 thereupon takes place. The search box 5 optionally has a plurality of lines which, similar to a pull-down menu, automatically pop up when a plurality of parameters 2 are possible in view of the search query.

In accordance with FIGURE X, a summary page 14 is produced on which all the parameters 2 and/or process data 3 are displaced which meet the search criterion. A summary page 14 is only produced if a plurality of parameters 2 and/or process data 3 are possible in view of the search result. Furthermore, a device page 16 can also be displayed which only displays the parameters 2 and/or process data 3 of the field instrument 1.

In accordance with FIG. 1, the search criterion is controlled on the basis of a semantic search with the aid of a domain-specific language.

Predefined search criteria can furthermore also be used. In this respect, specific parameters 2 and/or process data 3 are suggested to the user for the search without him having made an input into the search box 5.

In accordance with FIG. 1, the search for parameters 2 and/or process data 3 is optionally carried out on the field instrument 1, with the search criterion being transmitted to the field instrument 1 and being evaluated in an evaluation unit in the field instrument 1. Only one input device or one input/display device is thereby required to be able to input the search query and to be able to display the search result. The search itself, however, runs on the field instrument 1 anyway present.

In accordance with FIG. 1, the search program 15 is prepared in a programming language for graphical user interfaces. The programming language can, for example be Java or C# and optionally associated development tools.

### REFERENCE NUMERALS

1 field instrument
2 parameters
3 process data
4 web application
5 search box
6 operating interface
7 data structure
10 autocomplete
12 parameter page
13 process data page
14 summary page
15 search program
16 instrument page

1. A method having a search program and a search box for searching and locating at least one of parameters and process data in a web application, with the web application being provided for operating and visualizing at least one field instrument,
wherein, for searching, the web application dynamically produces at least one of the parameters and the process data from an operating interface at the running time, with the operating interface having at least one searchable data structure.

2. The method in accordance with claim 1, wherein the data structure has contents of an application description file.

3. The method in accordance with claim 1, wherein the data structure has dynamic values having properties of the field instrument.

4. The method in accordance with claim 1, wherein, on an input of parameters and/or process data into the search box, suggestions are displayed by means of an autocomplete function.

5. The method in accordance with claim 1, wherein the parameters and/or the process data displayed in the search box are clicked directly and a direct jump to a corresponding parameter page and/or process data page thereupon takes place.

6. The method in accordance with claim 1, wherein a summary page is produced on which all the parameters and/or process data are displayed which correspond to the search criterion.

7. The method in accordance with claim 1, wherein the search criterion is controlled on the basis of a semantic search with the aid of a dynamic-specific language.

8. The method in accordance with claim 1, wherein the search for parameters and/or process data is carried out on the field instrument, with the search criterion being transmitted to the field instrument and being evaluated in the field instrument.

9. The method in accordance with claim 1, wherein the search program is prepared in a programming language for a graphical operating interface.
